(19) United States
(12) Patent Application Publication
(10) Pub. No.: US 2025/0080989 A1
(43) Pub. Date: Mar. 6, 2025

(54) IMEI TRACKING PREVENTION

(71) Applicant: Private Tech Inc., Washington, DC (US)

(72) Inventors: Michael Howard Paesano, Falls Church, VA (US); Samuel Norman Litwin, New York, NY (US); John McKinstry Doyle, Washington, DC (US); Benny Tran, New York, NY (US); Stephen James Dowhy, Washington, DC (US); Manzurur Rahman Khan, Astoria, NY (US); Nicholas John Espinoza, Accokeek, MD (US); David Seth Dunn, Washington, DC (US); Yuna Wang, Brooklyn, NY (US)

(21) Appl. No.: 18/820,019

(22) Filed: Aug. 29, 2024

Related U.S. Application Data
(60) Provisional application No. 63/535,352, filed on Aug. 30, 2023.

(51) Int. Cl. H04W 12/71; H04W 12/06; H04W 12/63

(52) U.S. Cl. CPC H04W 12/71; H04W 12/06; H04W 12/63

(57) ABSTRACT

A mobile device or a method performed by a mobile device for protecting user privacies by swapping IMEI values. The mobile device accesses an IMEI value stored by and corresponding to the mobile device, selects a managed IMEI value from a pool of candidate IMEI values, and replaces the IMEI value with the managed IMEI value. In response to receiving an IMEI request from a wireless entity, the mobile device provides the managed IMEI value to the wireless entity. In response to receiving an IMEI request from an authentication service, the mobile device provides the IMEI value corresponding to the mobile device to the authentication service.

### CROSS-REFERENCE TO RELATED APPLICATION

This application claims the benefit of priority of U.S. Provisional Application, No. 63/535,352, filed on Aug. 30, 2023, which is incorporated by reference herein in its entirety.

### TECHNICAL FIELD

The disclosure generally relates to the field of mobile devices, and specifically to device authentication and security.

### BACKGROUND

The international mobile equipment identity (IMEI) value is a unique identifier for each mobile device. It is often used for network authentication and fraud prevention but also poses significant privacy risks if misused. For example, an IMEI value can be a tool for surveillance. Web services can use it to track the device's location, essentially monitoring a user's movements without the user's consent. This capability can be exploited in various ways, ranging from consumer platform overreach to unauthorized tracking by malicious actors.

For example, companies might track a user's IMEI value across different networks to compile a detailed profile of the user's activities and preferences. This information could be used for invasive targeted advertising, where ads are tailored based on the invasive tracking of your personal device usage. As another example, in environments where personal freedom is at risk, the ability to trace a user's mobile device through its IMEI value compromises the user's anonymity. This is particularly concerning for activists and individuals in oppressive regimes, where being identified can have serious repercussions.

However, since IMEI values are always accessible to telecom operators (or those posing as operators) via a simple network request, it is very difficult for users to protect their IMEI values.

### SUMMARY

Embodiments described herein solve the above-described problem by compiling a pool of candidate IMEI values, and enabling a mobile device to store its original IMEI value and report it for fraud and theft prevention purposes, but replace its original IMEI value with one of the candidate IMEI values corresponding to another device for response to certain (often unauthenticated) network requests.

In some embodiments, a mobile device accesses its IMEI value corresponding to itself and stored in its hardware, selects a managed IMEI value from a pool of candidate IMEI values, and replaces the IMEI value corresponding to itself with the managed IMEI value, moving the original IMEI value into storage at the application layer where it can be queried over authenticated channels to comply with anti-theft and fraud requirements. In some embodiments, the selection of the managed IMEI value may include querying an IMEI server that is configured to check out the managed IMEI value from the pool of candidate IMEI values. Once the managed IMEI value is checked out, it cannot be used by another mobile device until it is checked in by the mobile device. In some embodiments, multiple IMEI values may be checked out by the mobile device, and the managed IMEI is selected by the mobile device from the set of IMEI values. In some embodiments, the managed IMEI value is selected randomly. Alternatively, the IMEI value is selected based on a geographic location of the mobile device. For example, a user of the mobile device may define one or more geographic boundaries (also referred to as geofences), the managed IMEI value changes as the mobile device moves from a first geographic boundary to a second geographic boundary.

The mobile device may receive IMEI requests from a wireless entity and/or an authentication service. In response to receiving an IMEI request from the wireless entity (e.g., carrier), the mobile device provides the managed IMEI value to the wireless entity. On the other hand, in response to receiving an IMEI request from the authentication service, the mobile device provides the IMEI value corresponding to the mobile device to the authentication service.

As such, it is possible to safeguard a mobile device's IMEI value from the wireless entity and/or web services as needed, and it can also be retrieved for authentication purposes that require the original IMEI value.

### BRIEF DESCRIPTION OF DRAWINGS

The disclosed embodiments have other advantages and features that will be more readily apparent from the detailed description, the appended claims, and the accompanying figures (or drawings). A brief introduction of the figures is below.

Figure (FIG.) 1 illustrates an example system environment for mobile device, a privacy service, and an authentication service for IMEI value swapping, in accordance with some embodiments.

FIG. 2 illustrates an example architecture of a mobile device, in accordance with some embodiments.

FIG. 3 illustrates an example architecture of a privacy service, in accordance with some embodiments.

FIG. 4A is a diagram depicting a communication pattern among a mobile device, wireless entity, authentication service, and privacy service, in accordance with some embodiments.

FIG. 4B is another diagram depicting a communication pattern among a mobile device, wireless entity, authentication service, and privacy service, in accordance with some embodiments.

FIG. 4C is another diagram depicting a communication pattern among a mobile device, wireless entity, authentication service, and privacy service, in accordance with some embodiments.

FIG. 5 is a diagram depicting a communication pattern among a mobile device, a first wireless entity, a second wireless entity, an authentication service, and a privacy service, in accordance with some embodiments.

FIGS. 6A-6I illustrate examples graphical user interfaces (GUI) of the carrier application that allows users to configure and review their privacy settings and identifiers being used, in accordance with some embodiments.

FIG. 7 is a flowchart of an example method for protecting user privacy by enabling swapping of IMEI values in a mobile device, in accordance with some embodiments.

FIG. 8 is a flowchart of an example method for protecting user privacy by facilitating swapping of IMEI values of mobile devices, in accordance with some embodiments.

FIG. 9 is a block diagram of an example computer suitable for use in the networked computing environment of FIG. 1.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The International Mobile Equipment Identity (IMEI) is a unique identifier for each mobile device, used primarily for network authentication. However, it carries significant privacy risks if misused. For instance, IMEI can facilitate surveillance, allowing web services to track a device's location and monitor a user's movements without consent, which can be exploited by various actors for consumer platform overreach or unauthorized tracking. Companies may track a user's IMEI across networks to create detailed profiles of their activities and preferences for invasive targeted advertising. Furthermore, in contexts where personal freedoms are threatened, tracing a mobile device via its IMEI compromises anonymity, posing severe risks to activists and individuals in oppressive regimes. Despite these risks, it is nearly impossible for users to protect their IMEI values since they are always accessible to telecom operators, or entities posing as them, through simple network requests.

Embodiments described herein solve the above-described problem by maintaining a pool of managed IMEI values, and making these IMEI values available to mobile devices, such that a mobile device is able to swap its original IMEI value with a managed IMEI value. Further, most mobile phones do not allow an application or a user to modify its IMEI value. Embodiments described herein solve this problem by providing a carrier application for mobile devices. The carrier application operates with elevated permissions that go beyond typical application capabilities. The carrier application enables a user to manage the mobile device's privacy settings, including setting up multiple personas associated with specific geofences, each with a different IMEI value. For example, when the mobile device enters a first geofence, a first IMEI associated with the first geofence is activated; when the mobile device enters a second geofence, a second IMEI associated with the second geofence is activated.

When a wireless entity requests an IMEI value from the mobile device, the mobile device transmits a managed IMEI value currently in use to the wireless entity. However, when certain authentication is to be performed, the mobile device transmits its original IMEI value to an authentication service. As a result, the wireless entity does not gain access to the IMEI value of the mobile device, and only specific authentication services may be able to obtain it. This prevents the wireless entity from tracking the IMEI value, thereby effectively safeguarding the user's privacy.

Additional details about the operations of the mobile devices and privacy service are described below with respect to FIGS. 1-9.

### Configuration Overview

FIG. 1 illustrates one embodiment of a system environment for mobile device IMEI swapping. As depicted in FIG. 1, environment 100 includes network 110, mobile device 120, authentication service 130, and privacy service 140.

While only one of each feature of environment is depicted, this is for convenience only, and any number of each feature may be present. Where a singular article is used to address these features, scenarios where multiples of those features are referenced are within the scope of what is disclosed.

Network 110 provides connections to the components of the system environment 100 through one or more sub-networks, which may include any combination of local area and/or wide area networks, using both wired and/or wireless communication systems. In some embodiments, network 110 uses standard communications technologies and/or protocols. For example, network 110 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via network 110 include gRPC, multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 110 may be represented using any suitable format, such as hypertext markup language (HTML), extensible markup language (XML), JavaScript object notation (JSON), structured query language (SQL). In some embodiments, some of the communication links of network 110 may be encrypted using any suitable technique or techniques such as secure sockets layer (SSL), transport layer security (TLS), virtual private networks (VPNs), Internet Protocol security (IPsec), etc. Network 110 also includes links and packet switching networks such as the Internet. In some embodiments, a data store belongs to part of the internal computing system of a server. In such cases, network 110 may be a local network that enables the server to communicate with the rest of the components.

The network 110 includes a cellular network 112. The cellular network 112 may be a global mobile network, e.g., a 3G, 4G, or 5G cellular network. The cellular network 112 is a collection of hardware, software, and devices that facilitates and provides wireless services for mobile devices 120. The cellular network 112 is connected to other networks, e.g., the Internet, to enable mobile devices 120 to communicate with other services, e.g., web services. The cellular network 112 is associated with a wireless entity 114, e.g., a mobile carrier that manages and operates the cellular network.

Mobile device 120 is a mobile device through which a user may make requests for services from privacy service 140 or authentication service 130 over network 110. Examples of mobile device 120 may be a smartphone, tablet, computer, satellite phone, Internet of Things (IoT) device, smart watch, or other mobile-enabled device. Mobile device 120 may be a mobile cellular device and may contain a subscriber identity module (SIM) card, embedded subscriber identity module (eSIM) card, or integrated subscriber identity module (iSIM). The SIM or eSIM card has a corresponding SIM or eSIM profile, which stores the unique identity of the subscriber. For example, the profile may store network connectivity information, key information, and authentication information for the mobile device 120 as well as any corresponding network settings. The profile contains an international mobile subscriber identity (IMSI) value, a unique identifier that identifies the subscriber (e.g., user of mobile device 120). When mobile device 120 connects to the cellular network 112, it provides the IMSI value to the network during authentication of the mobile device. In some embodiments, more than one eSIM profile may reside on mobile device 120. In some embodiments, mobile device 120 executes a carrier application to communicate with the privacy service 140.

The mobile device 120 is also associated with an IMEI value, which is a unique number used to identify mobile devices. The IMEI value is usually embedded in the mobile device 120's hardware, such as a modem or a baseband processor, which is responsible for handling cellular communication. The IMEI value is often stored in a non-volatile memory chip, such that it remains intact even when the device is powered off. In some embodiments, the IMEI value is also stored in firmware of the mobile device 120, such as a read-only memory or flash memory that is reserved for device identifiers and configuration settings. When the mobile device connects to the cellular network 112, its IMEI value is transmitted to the wireless entity 114 for validation and logging. The wireless entity may use this information to manage devices on its cellular network 112, detect fraud, and block stolen devices. The IMEI value of the mobile device 120 may also be stored in a network database accessible by one or more wireless entities 114 for purposes like blacklisting or tracking.

Generally, the IMEI value is a 15-digit number that uniquely identifies a device within the global mobile network (e.g. the cellular network 112). In some embodiments, the structure of the IMEI may include a first 8 digits that represent the model and origin of the device, the following 6 digits that represent a serial number associated with a manufacture of the device, and a final digit used to verify the entire IMEI value for correctness, using a predetermined algorithm, e.g., the Luhn algorithm. The purpose of IMEI values is to identify the device on the cellular network 112. Regulations around IMEI values vary by country, but many regions require that the IMEI be transparent to the wireless entity 114 (e.g., a mobile operator). The wireless entity 114 can use the IMEI value to verify the device and ensure it hasn't been reported stolen or blacklisted. If a device is stolen, an owner of the device can report the IMEI value to their carrier, who can then blacklist the device, making it unusable on the cellular network 112.

While the availability of IMEIs provides valuable security benefits, it also poses privacy risks if misused. For instance, unauthorized tracking could occur if the IMEI value of the mobile device 120 is accessed by malicious entities. The embodiments described herein solve this problem by having a carrier application 122 installed on the mobile device 120 that can prevent the original IMEI value of mobile device 120 from being tracked. The carrier application 122 operates with elevated permissions that go beyond typical application capabilities. These elevated permissions allow the carrier application 122 to interact with the mobile device 120's hardware (e.g., a modem, or a baseband processor) and firmware where the IMEI value is stored.

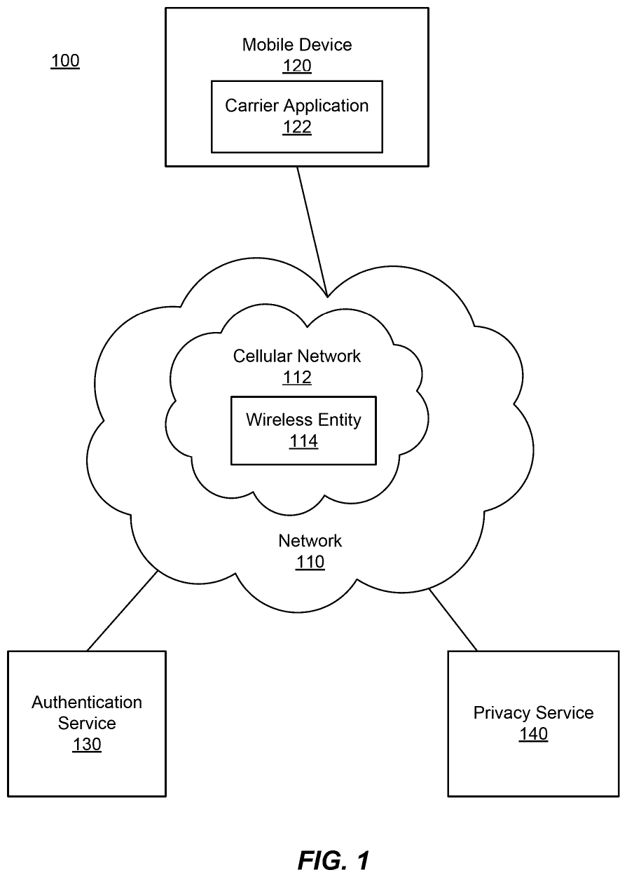

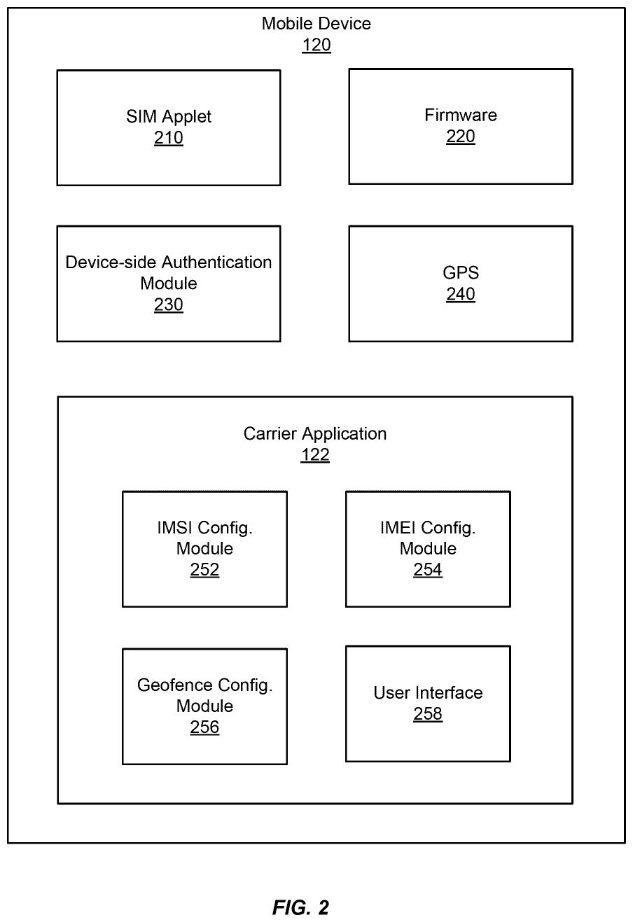

Traditionally, the hardware (e.g., a modem, or a baseband processor), that handles communication with the cellular network 112, often has the IMEI value programmed into its memory to ensure that the IMEI value is available for identification and authentication purposes. The carrier application 112 receives a managed IMEI value from the privacy service 140, where a pool of IMEI values (also referred to as candidate IMEI values or managed IMEI values) is managed. The carrier application 112 accesses the original IMEI value corresponding to the mobile device 120 and replaces the original IMEI value with the managed IMEI value. The operations of mobile device 120 and the privacy service 140 are described in further detail below with reference to at least FIGS. 2-9.

Authentication service 130 is a computing server that processes requests for service from mobile device 120. Authentication service 130 may store information relevant to the request, such as a receipt identifier (receipt ID). A receipt ID is an identifier that corresponds to the requested service and comprises a cryptographically secured value. In some embodiments, authentication service 130 may randomly generate the receipt ID. Authentication service 130 may perform a validation of the receipt ID upon request, for example in response to a request from privacy service 140.

In some embodiments, the authentication service 130 may be associated with the privacy service 130, performing authentication for mobile devices registered with the privacy service 130. In such a case, the authentication service 130 requires verifying the original IMEI value of the mobile device 120. The authentication service 130 requests for an IMEI value from the mobile device 120. In response to receiving the IMEI request, the carrier application 112 causes the original IMEI value to be transmitted to the authentication service 130.

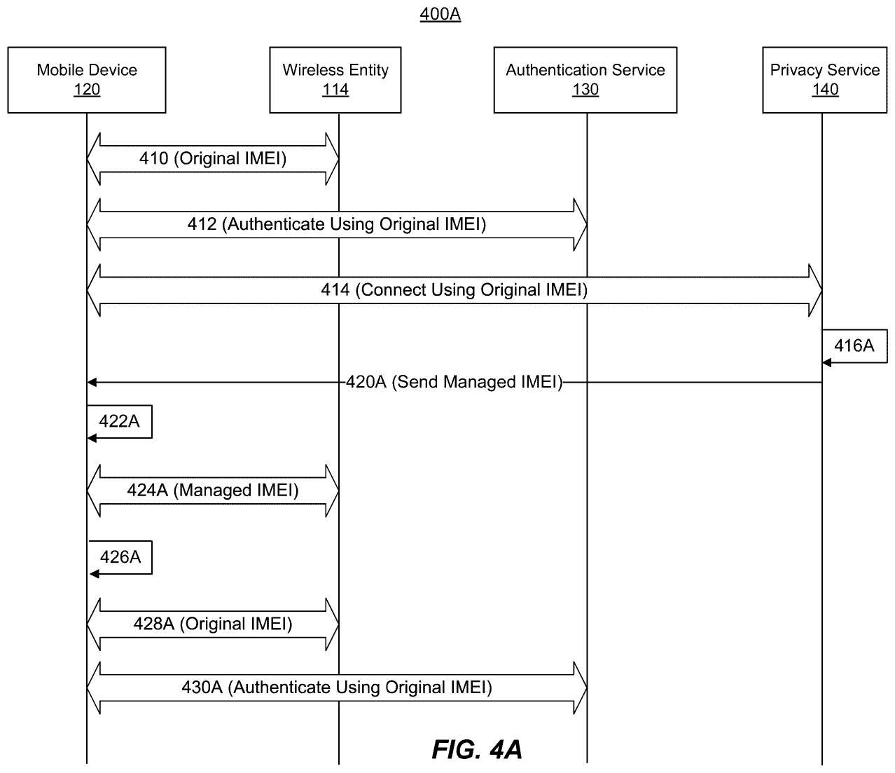

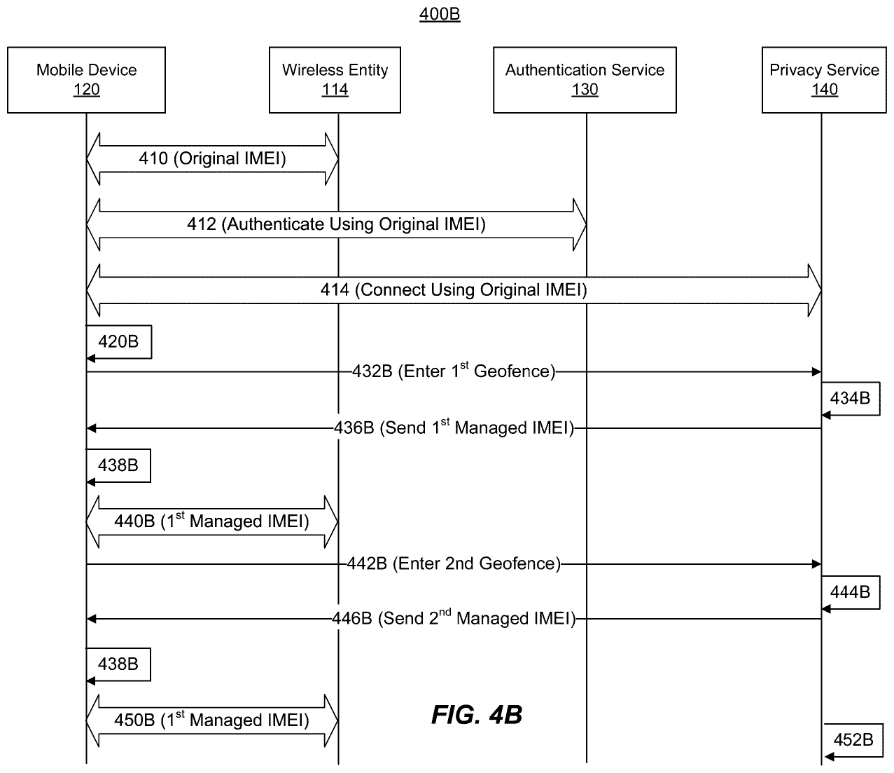

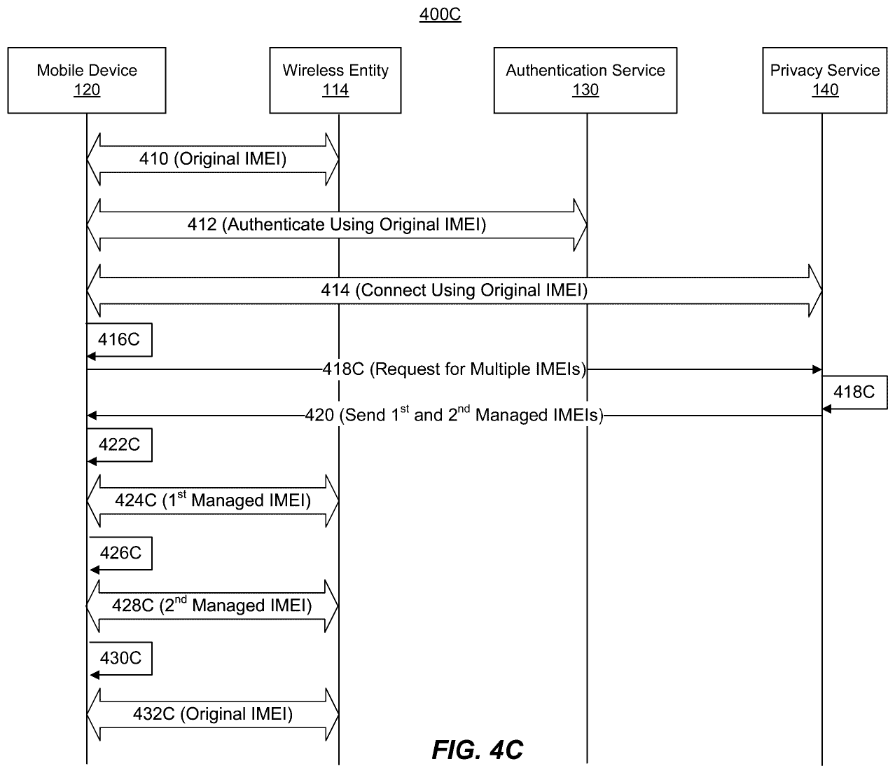

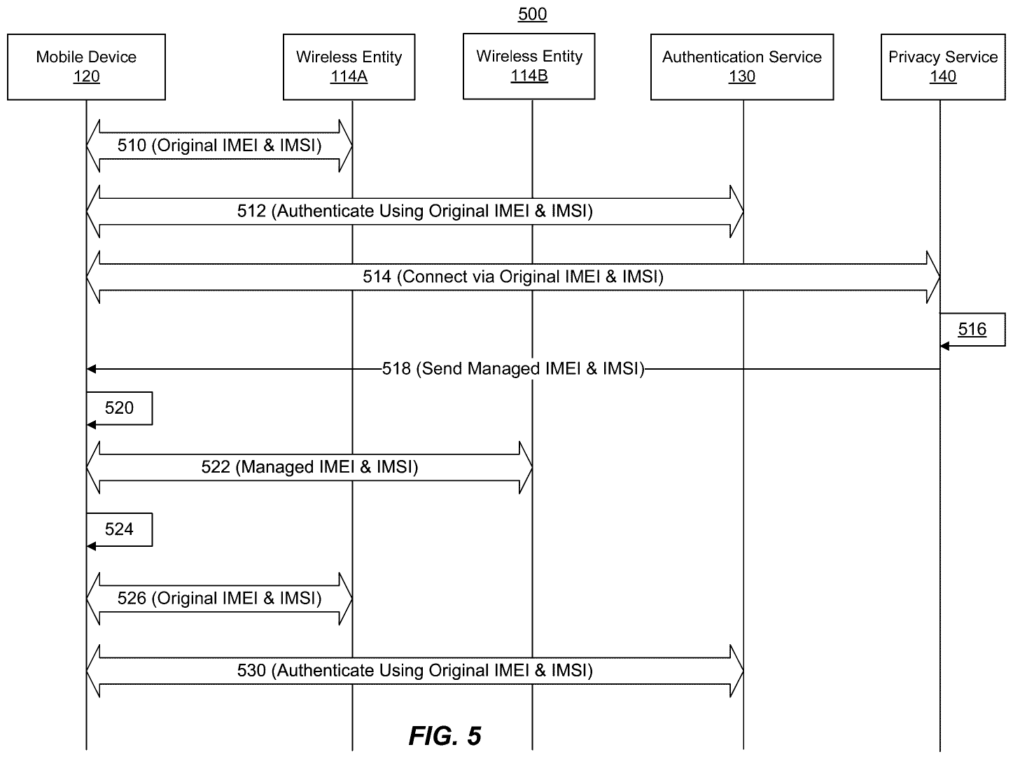

In some embodiments, the authentication service 130 may be a third-party server that performs authentication for other services. In such a case, a user of the mobile device 120 may determine whether they would like the original IMEI value of the mobile device or a managed IMEI value to be sent to the authentication service 130. The communication patterns among the mobile device 120, the wireless entity 114, the authentication service 130, and the privacy service 140 are further described below with respect to FIGS. 4A-4C and 5.

Privacy service 140 operates as a computing server that manages IMEI values for mobile device 120. This process helps to protect the original IMEI value of mobile device 120 from being tracked by services or wireless entity 114. Privacy service 140 maintains a pool of IMEI values, selects one or more from this pool for mobile device 120, and transmits the selected IMEI values to mobile device 120. When an IMEI value is sent to a mobile device 120, that IMEI value is checked out, i.e., it is designated as used and becomes unavailable for other mobile devices 120.

It should be noted that there are additional hardware and software identifiers capable of tracking devices and their users, including IMSI values, media access control (MAC) addresses, and advertising identifiers (Ad IDs). In some embodiments, privacy service 140 is further configured to manage other identifiers such as IMSI values, MAC addresses, and Ad IDs.

An IMSI value is a unique number associated with the cellular network 112. It is used for identifying the user of the cellular network 112. The IMSI is stored in a SIM or eSIM card. The IMSI value typically includes up to 15 digits, which are divided into three parts: (1) mobile country code (MCC), which is a three-digit code that identifies a subscriber (i.e., a user of the mobile device) home country, (2) mobile network code (MNC), which is a two or three-digit code that identifies the wireless entity 114 to which the subscriber belongs within the home country, and (3) mobile subscriber identification number (MSIN), which is a unique number that identifies the subscriber to the wireless entity 114. In some embodiments, the privacy service 140 also maintains a pool of IMSI values, selects one or more from this pool for mobile device 120, and transmits the selected IMSI values to mobile device 120. When an IMSI value is sent to a mobile device 120, it is designated as used and becomes unavailable for other mobile devices 120.

A MAC address is a unique identifier assigned to network interfaces for communications at a data link layer of a network segment. MAC addresses are often used as network addresses for network communications between devices on a local network, including Ethernet and Wi-Fi. Each MAC address is a 12-digit hexadecimal number (48 bits in length). It is typically presented in the format of: XX:XX:XX:XX:XX:XX, where each X is a hexadecimal digit, ranging from 0 to F. The first half of a MAC address (first six hexadecimal digits) identifies the manufacturer or vendor of the device (often referred to as the Organizational Unique Identifier or OUI), and the second half is a unique value assigned by the manufacturer to that specific device. Despite their importance in network communication, MAC addresses can also pose privacy risks since they can potentially be used to track devices. In some embodiments, the privacy service 140 also maintains a pool of MAC addresses, selects one or more from this pool for mobile device 120, and transmits the selected MAC addresses to mobile device 120. When a MAC address is sent to a mobile device 120, it is designated as used and becomes unavailable for other mobile devices 120.

An Ad ID is a unique identifier associated with a mobile device that is used for tracking and personalizing ads displayed on the device. It serves as a way for advertisers to deliver targeted advertisements based on user behavior, preferences, and interests without directly identifying the individual. For example, Google Advertising ID (AAID) is used on Android devices. An AAID allows advertisers to track user interactions with ads across apps on their devices. Apple's Identifier for Advertisers (IDFA) is used on iOS devices. An IDFA performs a similar function to AAID, enabling advertisers to deliver personalized ads based on user activity. The use of Ad IDs has raised privacy concerns. In some embodiments, the privacy service 140 also maintains a pool of Ad IDs, selects one or more from this pool for mobile device 120, and transmits the selected Ad IDs to mobile device 120. When an Ad ID is sent to a mobile device 120, it is designated as used and becomes unavailable for other mobile devices 120.

Privacy service 140 may communicate with mobile device 120 or from authentication service 130. The privacy service 140 may require that the mobile device 120 undergo authentication via the authentication service 130 using its original IMEI and/or IMSI prior to establishing communication. In some embodiments, privacy service 140 and/or authentication service 130 may employ a heightened security standard and an isolated environment for connecting with mobile device 120 and receiving data from mobile device 120 that may include personally identifiable information or other sensitive information. The operations of mobile device 120, authentication service 130, and privacy service 140 are described in further detail below with respect to FIGS. 2-9.

### Mobile Device

FIG. 2 illustrates one embodiment of exemplary modules operated by a mobile device. As depicted in FIG. 2, mobile device 120 includes SIM applet 210, carrier application 122, and device-side authentication module 230. The mobile device 120 also includes firmware 220, and a global positioning system (GPS) 240. The modules depicted with respect to mobile device 120 are merely exemplary; fewer or additional modules may be used to achieve the activity disclosed herein.

SIM applet 210 is a small program inside the embedded sim card (eSIM) of mobile device 120, installed on an eSIM profile. SIM applet 210 provides a way for other applications, such as carrier application 122, to access information pertaining to the eSIM (e.g., network quality, device status) and to modify the eSIM profile it is installed on. In some embodiments, more than one eSIM profile may reside on mobile device 120. In this case, each eSIM profile has a copy of the SIM applet 210. Carrier application 122 may configure one eSIM profile of many stored eSIM profiles to be an active eSIM profile. Carrier application 122 may at any point replace the active eSIM profile with another eSIM profile.

The firmware 220 may be embedded within a modem or baseband process of the mobile device 120. This firmware 220 is configured to handle radio communications between the mobile device 120 and the cellular network 112, including voice calls, SMS messaging, and data transmission. The firmware 220 includes an IMEI storage configured to store an IMEI which may be the original IMEI of the mobile device 120, or a managed IMEI that is currently being used. The IMEI serves as an identifier for the modem hardware. When the mobile device 120 tries to connect to a cellular network 112, the network 112 may request the IMEI to verify the device's legitimacy. Responsive to receiving the request, the firmware 220 sends the IMEI to the network 112.

The GPS 240 functions by using satellite signals to determine its location anywhere on the globe. In some embodiments, the GPS 240 may communicate with a network of about 24 satellites orbiting the Earth. Some of these satellites, managed by the US Department of Defense, are positioned in such a way that from any point on Earth, a GPS receiver can usually detect at least four of them. Each satellite continually transmits messages that include the satellite's current position, orbit, and the exact time the message was transmitted. The GPS 240 listens for these signals. To determine its position, the GPS 240 gathers data from at least four satellites and uses the gathered data to calculate the mobile device 120's three-dimensional position (latitude, longitude, and altitude).

Device-side authentication module 230 seeks authentication of mobile device 120 with blinded tokens. Device-side authentication module 230 may generate values at various stages in the process. For example, device-side authentication module 230 may generate a token, a recovery identifier (RID), a public key, or a private key. A token may be a randomly generated number representative of mobile device 120. The token may be epoch-specific, in that the token is specific to a time interval in which device-side authentication module 230 generated the token. A RID is a unique value known only to mobile device 120 that may serve as a unique identity for mobile device 120. A public key is a publicly known cryptographic key that can be used by any party to encrypt messages for received by a party that has access to the public key's corresponding private key. The private key corresponds to the public key and allows the party to decrypt messages encrypted with the public key. Device-side authentication module 230 may manipulate the generated values or apply cryptographic techniques. Device-side authentication module 230 may blind or unblind values (e.g., blinding a token, unblinding an encrypted blinded token) or may decrypt values (e.g., decrypting a nonce with a private key).

In some embodiments, the device-side authentication module 230 also sends the IMEI value of the mobile device 120 to an authentication service 130, which in turn uses the IMEI value for authentication. In some embodiments, the device-side authentication module 230 sends an original IMEI value of the mobile device 120 to the authentication service 130 responsive to a request from the authentication module 230. Alternatively, the device-side authentication module 230 sends a managed IMEI value to the authentication service 130, depending on the purpose of the authentication.

Carrier application 122 is an application on mobile device 120 that may provide mobile carrier services to the user of mobile device 120. The carrier application 122 includes an IMSI configuration module 252, an IMEI configuration module 254, a geofence configuration module 256, and a user interface 258. The IMSI configuration module 252 may allow the user of mobile device 120 to connect wirelessly to the cellular network 112, make phone calls, or use cellular data. Carrier application 122 may communicate with SIM applet 210 and may access or modify information such as the one or more eSIM profiles. For example, the IMSI configuration module 252 may download an eSIM profile, configure an eSIM profile as active, or transmit an application protocol data unit (APDU) command to change the IMSI value of an eSIM profile. Carrier application 122, via the privacy service 140, may also modify or add to the contents of an IMSI table, a table that associates an IMSI value with mobile device 120 or an eSIM profile on mobile device 120. The IMSI table may commonly reside in or be a subcomponent of a home subscriber server (HSS).

The IMEI configuration module 254 interacts with privacy service 140 to obtain one or more managed IMEI values. The IMEI configuration module 254 has elevated permission that allows itself to replace the existing IMEI value with a managed IMEI value. Once the existing IMEI value is replaced with the managed IMEI value, the firmware 220 is caused to handle all radio communications with the cellular network 112 using the managed IMEI value.

The geofence configuration module 256 is configured to set up geofences, associated with specific IMEI values. Upon the GPS 240 detecting that the mobile device 120 has entered a designated geofence, the associated IMEI value for that geofence is activated to replace a current IMEI value. In some embodiments, multiple geofences are set up, each associated with a separate IMEI value. For example, as mobile device 120 enters a first geofence, its IMEI value switches to a first designated IMEI value. Upon entering a second geofence, the device's IMEI value changes to a second designated IMEI value, and this pattern may continue with additional geofences. This dynamic adjustment occurs as the mobile device transitions from one geofence to another.

In some embodiments, each geofence is associated with a specific pair of IMEI/IMSI values. As mobile device 120 enters a first geofence, its IMEI/IMSI values are updated to correspond with a first IMEI/IMSI pair designated for that geofence. Similarly, entering a second geofence triggers the device to switch its IMEI/IMSI values to those associated with a second IMEI/IMSI pair, and this process may repeat for additional geofences.

In some embodiments, each geofence corresponds to a persona, which includes a specific IMEI value, IMSI value, MAC address, and/or Ad ID, among other identifiers. Users have the flexibility to create multiple personas as desired. Mobile device 120 automatically switches between these personas depending on the user's geographic location, aligning its identifier settings with the relevant persona associated with the current geofence.

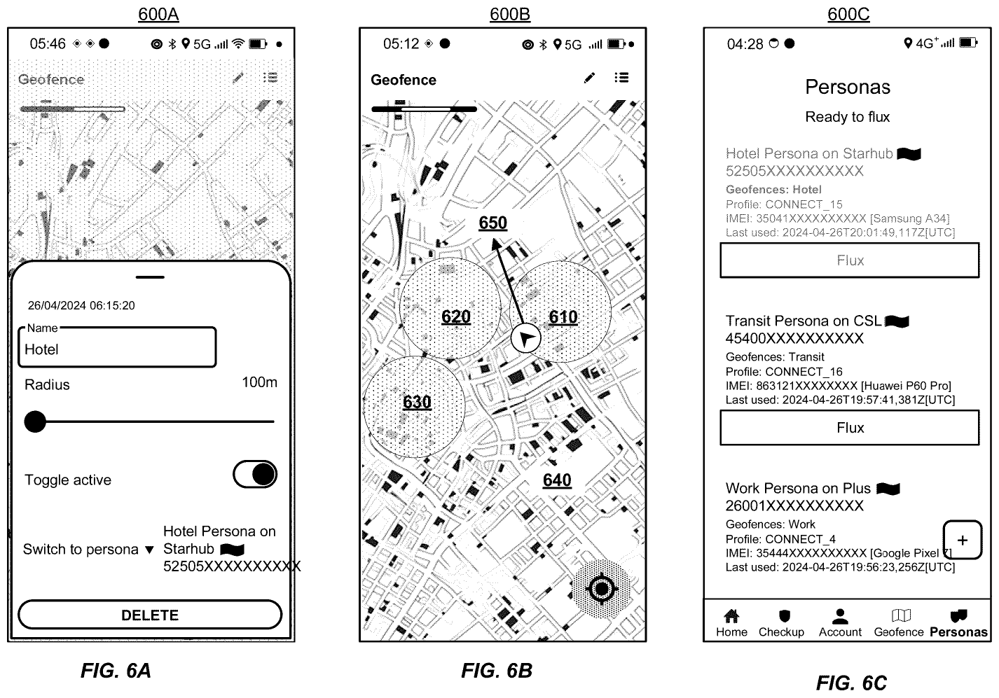

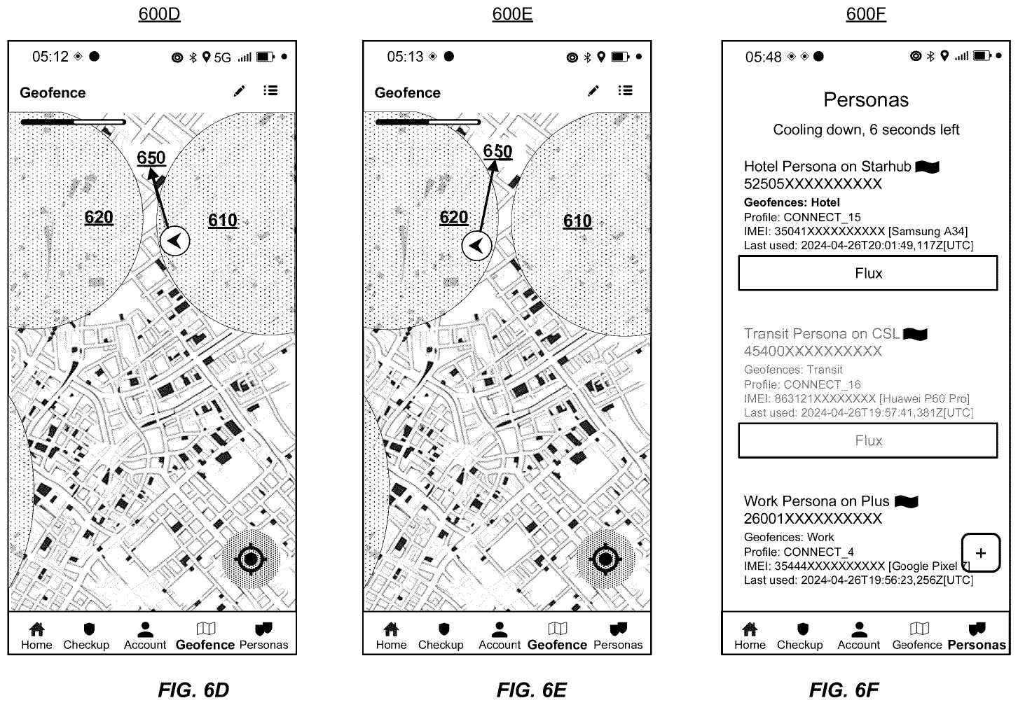

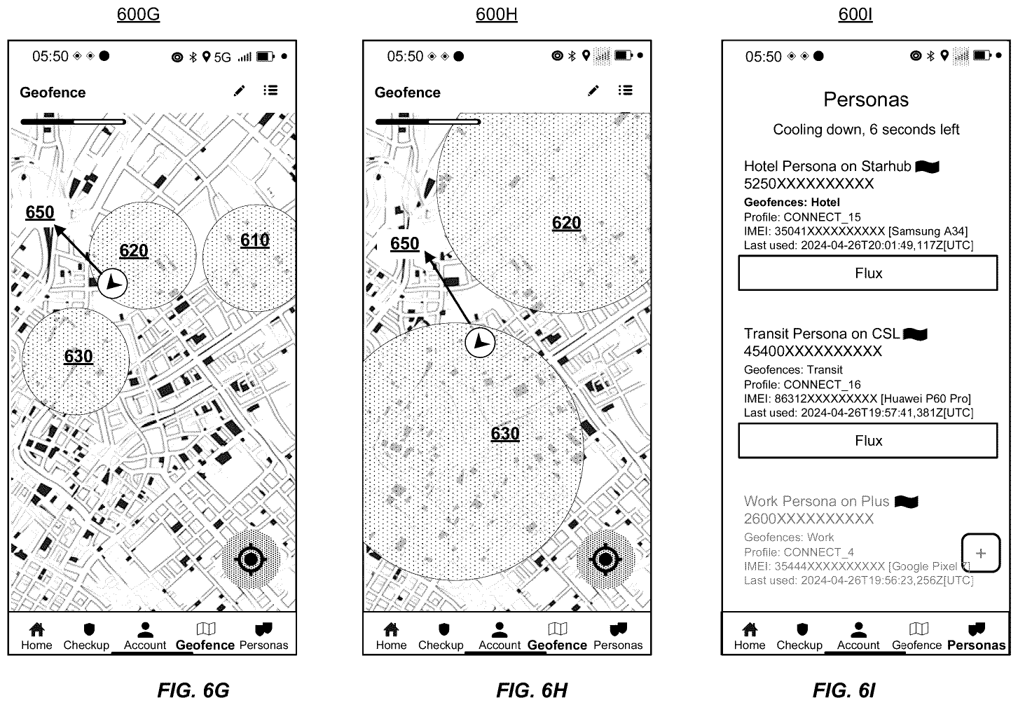

The user interface 258 allows users to onboard with privacy service 140, and set up their desired geofences and/or personas. In some embodiments, the identifiers (e.g., IMEI, IMSI, MAC address, and/or Ad ID) are randomly chosen by the privacy service 140 at a predetermined frequency, e.g., every day, every hour, every 10 minutes, every minute, etc. In some embodiments, the identifiers are chosen by the user. The user can see their current set of identifiers via the user interface 258 and/or manually change the current set of identifiers to a different set. Example graphical user interfaces are described below with respect to FIGS. 6A-6I.

### Privacy Service

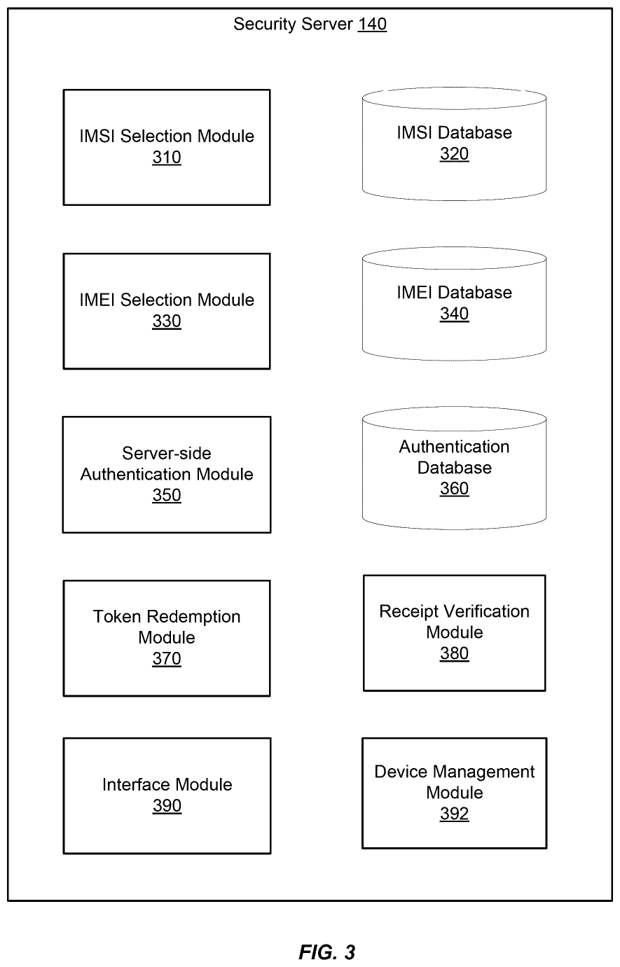

FIG. 3 illustrates one embodiment of exemplary modules operated by a privacy service 140. As depicted in FIG. 3, privacy service 140 includes IMSI selection module 310, IMSI value database 320, IMEI selection module 330, IMEI database 340, server-side authentication module 350, authentication database 360, token redemption module 370, receipt verification module 380, interface module 390, and a device management module 392. The modules depicted with respect to privacy service 140 are merely exemplary; fewer or additional modules may be used to achieve the activity disclosed herein. For example, the privacy service 140 may also include a MAC address database, a MAC address selection module, an Ad ID database, and an Ad ID selection module, among others.

IMSI database 320 maintains a pool of managed IMSI values. The IMSI selection module 310 selects an IMSI value from this pool and transmits it to mobile device 120. When an IMSI value is transmitted to and activated on the mobile device 120, IMSI selection module 310 updates IMSI database 320 to associate that IMSI value with the mobile device 120, thereby making it unavailable for other devices. If the mobile device 120 transitions to a new IMSI value, the IMSI selection module 310 may de-associate the previous IMSI value from the mobile device 120, making it available for other mobile devices again.

In some embodiments, IMSI selection module 310 selects IMSI values unprompted by mobile device 120. For example, the IMSI selection module 310 may select a new IMSI value every day, every hour, every a few minutes, etc., and send the new IMSI value to the mobile device 120. In some embodiments, IMSI selection module 310 selects IMSI values in response to a request by mobile device 120. This may be caused by a user request, or device configuration. For example, a geofence may be set for the mobile device 120. When the mobile device 120 enters the geofence, it sends a request to the privacy service 140, causing the IMSI selection module 310 to select a new IMSI value and transmits the new IMSI value to the mobile device 120.

Similarly, the IMEI database 340 stores and maintains a pool of IMEI values. IMEI pool includes multiple IMEI values. As previously discussed, each IMEI value is associated with a specific device. In some embodiments, used mobile devices are collected, and the IMEI pool is sourced from these used phones. In some embodiments, the IMEI database 340 also stores data about those used mobile devices that are associated with the IMEI values. For example, a particular IMEI value may be associated with a white iPhone 11, and color white and iPhone 11 are stored relationally with the IMEI value.

IMEI selection module 330 is configured to manage allocation of IMEI values from the IMEI value database 340 to ensure that each device receives a unique and valid IMEI for the use during network interactions. The IMEI selection module 330 maintains an assignment record that logs which IMEI values have been assigned to which devices, and which IMEI values are available for assignment to devices. In response to receiving a request from a device for a managed IMEI value, the IMEI selection module 330 selects an IMEI value that has not been assigned to a device and transmits the selected IMEI value to the device. In some embodiments, a user of a device is allowed to select an IMEI value based on a desired phone color and model. For example, a user may select a white iPhone 11, and a candidate IMEI in the pool associated with a white iPhone 11 is sent to a device of the user.

In some embodiments, the user can set multiple geofences, each associated with a separate IMEI value. Following the user's settings, the IMEI selection module 330 selects several IMEI values, with each one corresponding to a user-set geofence, and transmits these IMEI values to mobile device 120. These IMEI values will continue to be used by mobile device 120 for their respective geofences unless the user updates their privacy settings again.

Receipt verification module 380 verifies a receipt ID corresponding to a request from mobile device 120. The request may be between mobile device 120 and authentication service 130. The request may include a request for service, such as a request for mobile device 120 to be provided with a cellular network. In response to the request, mobile device 120 may receive a confirmation of the request in the form of a receipt ID from authentication service 130. Receipt verification module 380, responsive to receiving the receipt ID from mobile device 120, communicates with authentication service 130 to verify the receipt. Receipt verification module 380 may check and/or modify data stored on privacy service 140, such as one or more tables stored in authentication database 360. Receipt verification module 380 may also engage in an RSA signing process, receiving a blinded token from mobile device 120, encrypting the blinded token in response to the verification of the receipt ID, and providing the token to the user. Further details of the method of receipt verification are discussed in FIG. 4A.

Token redemption module 370 processes a request from mobile device 120 to redeem a token. A token serves as proof that mobile device 120 requested a service and that privacy service 140, through receipt verification module 380, verified the receipt corresponding to the service. Token redemption module 370 redeems the token by using tables stored in authentication database 360 to check the token's validity and record the use of the token. Token redemption module 370 may receive and store a public key provided by mobile device 120. Further details for the token redemption process are discussed in FIG. 4B.

Server-side authentication module 350 authenticates mobile device 120 using a public key authentication process. A public key authentication process is a process where encryption and decryption are performed using separate keys, a public key known to both privacy service 140 and mobile device 120 and a private key known only to mobile device 120. Server-side authentication module 350 may authenticate mobile device 120 in response to a request for a service (e.g., the service mobile device requested which produced the receipt).

In some embodiments, the server-side authentication module 350 authenticates mobile device 120 for accessing the privacy service 140. In such a case, the original IMEI value of the mobile device 120 is required to be verified. Alternatively, the server-side authentication module 350 may authenticate mobile device 120 for accessing another web service. In such a case, the user can configure its carrier application 122 to cause the mobile device 120 to use its managed IMEI value to perform authentication.

Authentication database 360 stores various blacklists and tables associated with the method of mobile device authentication with blinded tokens. Tables may include a receipt ID blacklist, a receipt authentication table, a token blacklist, a public key table, an authentication nonce table, or an authentication token table.

The interface module 390 is configured to communicate with mobile devices via carrier application 122 installed thereon. In some embodiments, the interface module 390 includes specific endpoints exposed by the privacy service 140 to interact with the carrier application 122. In some embodiments, the interface module 390 uses an application programming interface (API) to receive requests from the carrier application 122 and transmit data, e.g., managed IMEI values.

The device management module 392 is responsible for registering new mobile devices into the privacy service 140 and removing mobile devices of users who no longer wish to access the privacy service 140. Only the registered mobile devices may receive managed IMEI values. In some embodiments, the device management module 392 is also configured to track each registered mobile device's privacy configurations and their assigned IMEI values. In some embodiments, the device management module 392 is also configured to trigger IMEI swapping at mobile devices based on their privacy configurations.

### Mobile Device IMEI Management

FIG. 4A is a diagram depicting a communication pattern 400A among a mobile device 120, wireless entity 114, authentication service 130, and privacy service 130, in accordance with some embodiments. First, the mobile device 120 and the wireless entity 114 establish communication, represented by arrow 410. The wireless entity 114 may be a mobile carrier. When a mobile device is powered on, it initializes its hardware and software components, including the firmware 220 responsible for communication with a cellular network associated with the wireless entity 114. The mobile device 120 may scan for available networks by searching for signals from nearby cell towers, and identify available networks by their broadcasted identifiers, such as a mobile network code (NMC) and a mobile country code (MCC). Once a suitable network is found, the mobile device 120 attempts to register with it. The registration process includes sending a location update request to the network. This request often includes the device's IMSI and IMEI. Once the wireless entity 114 receives the request, it authenticates the mobile device 120 to ensure it is allowed to access the network. This authentication may include sending an authentication request to the device 120, which may include a random challenge. Responsive to receiving the authentication request, the mobile device 120 generates a response using its stored authentication key and the received challenge, using a predetermined algorithm. Responsive to receiving the response, the wireless entity 114 verifies the response by comparing it with the expected result. If they match, the mobile device 120 is authenticated, and the cellular network 112 associated with the wireless entity 114 and the mobile device 120 establish communication. As such, the mobile device 120 is able to access the cellular network 112 via its original IMEI.

Next, the mobile device communicates with an authentication service 130, represented by arrow 412. The authentication service 130 may be a third-party authentication service or associated with privacy service 140. The authentication service 130 authenticates the mobile device 120 based in part on its original IMEI value. In some embodiments, the authentication is further based on other user information corresponding to an original persona of a user of the mobile device 120, such as an email address, a phone number, among others. In response to successful authentication, the mobile device 120 establishes a connection with privacy service 140, represented by arrow 414. When the mobile device 129 first establishes a connection with the privacy service 140, there may be an onboarding process, in which the original IMEI value and/or other user information are registered with the privacy service 140. In some embodiments, a carrier application 122 is installed on the mobile device 120 that allows the mobile device 120 to communicate with the privacy service 140, e.g., receive managed IMEI values, and configure its IMEI settings, e.g., set up geofences.

Once the mobile device 120 is registered with the privacy service 140, the privacy service 140 accesses its pool of managed IMEI values to select an available managed IMEI value from the pool, represented by arrow 416A. As we previously discussed, each IMEI value corresponds to a specific hardware mobile device, e.g., a white iPhone 11. In some embodiments, users can choose a color and/or model of a desired mobile device, and the privacy service 140 will then select an IMEI that matches a device with the chosen specification.

The privacy service 140 sends the selected IMEI value to the mobile device 120, represented by arrow 420A. In response to receiving the managed IMEI value from the privacy service 140, the mobile device 120 updates its IMEI value to the managed IMEI value (represented by arrow 422A), and uses the managed IMEI value to establish communication with the wireless entity 114 (represented by arrow 424A).

In some embodiments, the user can manually select the managed IMEI or the original IMEI for communication with the wireless entity 114. For example, the user may select to use the original IMEI value (represented by arrow 426A), and the mobile device 120 is caused to switch back to its original IMEI value, and uses its original IMEI value to communicate with wireless entity 114 (represented by arrow 428A). In some embodiments, the user can set one or more conditions, when at least one of these conditions are satisfied, the mobile device 120 automatically switches the IMEI values between the original IMEI value. and the managed IMEI value. The conditions may include (but are not limited to) when the mobile device 120 enters a particular geofence, and/or when the mobile device 120 requests for a particular service (e.g., authentication service 130). For example, when a user requests to authenticate via the authentication service 130 again, the mobile device 120 automatically switches itself back to its original IMEI, such that the authentication is performed using the original IMEI (represented by arrow 430A).

FIG. 4B is another diagram depicting a communication pattern 400B among a mobile device 120, wireless entity 114, authentication service 130, and privacy service 140, in accordance with some embodiments. Similar to FIG. 4A, the mobile device 120 establishes communication with wireless entity 114 using its original IMEI (represented by arrow 410), authenticates itself using its original IMEI (represented by arrow 412), and establishes communication with privacy service 140 (represented by arrow 414).

After the mobile device 120 is registered with the privacy service 140, a user can set up a few geofences, each to be associated with a separate IMEI (represented by 420B). Once the mobile device 120 enters a first geofence (previously set up), the mobile device 120 sends a request to the privacy service 140 representing a managed IMEI value (represented by arrow 432B). In response to receiving the request, the privacy service 140 selects an available IMEI from the pool (represented by arrow 434B), and sends the selected IMEI value (also referred to as a 1^{st} managed IMEI value) to the mobile device 120 (represented by arrow 436B). In response to receiving the IMEI value from the privacy service 140, the mobile device 120 updates its IMEI value to the managed IMEI value (represented by arrow 438B) and establishes communication with the wireless entity 114 using the managed IMEI value (represented by arrow 440B). Again, once the mobile device 120 enters a second geofence (previously set up), the mobile device 120 sends another request to the privacy service 140 (represented by arrow 442B), causing the privacy service 140 to select a second managed IMEI value (represented by arrow 444B), and sends the second managed IMEI value to the mobile device 120 (represented by arrow 446B). Responsive to receiving the second IMEI value, the mobile device 120 switches its IMEI value to the second IMEI value (represented by arrow 438B) and establishes communication with wireless entity 114 with the second IMEI value (represented by arrows 438B). After that, the privacy service 140 may update its IMEI database to check in the first IMEI value, making it available to be assigned to other mobile devices again. This process may continue to repeat until the user updates their privacy set up via the carrier application 122.

FIG. 4C is another diagram depicting a communication pattern 400C among a mobile device 120, wireless entity 114, authentication service 130, and privacy service 130, in accordance with some embodiments. Similar to FIG. 4A, the mobile device 120 establishes communication with wireless entity 114 using its original IMEI (represented by arrow 410), authenticates itself using its original IMEI (represented by arrow 412), and establishes communication with privacy service 140 (represented by arrow 414).

After the mobile device 120 is registered with the privacy service 140, a user of the mobile device 120 may set a few conditions that require the use of multiple IMEI values via the carrier application 122 (represented by arrow 416C). For example, the user may set several time periods, each to be associated with a separate IMEI value. Alternatively, the user may set several geofences, each to be associated with a separate IMEI value. Once the user completes their setup with the carrier application 122, the carrier application 122 sends a request to the privacy service 140, requesting for a number of IMEI values (represented by arrow 418C). Upon receiving the request, the privacy service 140 selects the requested number of IMEI values from its pool (represented by arrow 418C) and sends the selected IMEI values (e.g., a first managed IMEI value and a second managed IMEI value) to the mobile device 120 (represented by arrow 420C), causing the mobile device 120 to store the IMEI values within the carrier application 122.

The mobile device 120 monitors the preset conditions. In response to determining that a first condition is satisfied (represented by arrow 422C), the mobile device 120 switches its IMEI value to a first managed IMEI value and establishes communication with wireless entity 114 using the first managed IMEI value (represented by arrow 424C). The first condition may be that the mobile device 120 enters a first preset geofence, a current time is within a first preset time of a day (e.g., 9:00 am to 5:00 pm, Monday through Friday), or a particular service is being used.

Again, in response to determining that a second condition is satisfied (represented by arrow 426C), the mobile device 120 switches its IMEI value to a second managed IMEI value and establishes communication with wireless entity 114 with the second managed IMEI value (represented by arrow 427C). In response to determining that none of the conditions is satisfied or a third condition is satisfied, the mobile device 120 switches its IMEI value to its original IMEI value, and establishes communication with the wireless entity 114 using the original IMEI value. For example, the third condition may be that certain web service requires authentication using the original IMEI value. This process may continue to repeat until the user updates its privacy set up via the carrier application.

FIG. 5 is a diagram depicting a communication pattern 500 among a mobile device 120, a first wireless entity 114A, a second wireless entity 114B, authentication service 130, and privacy service 130, in accordance with some embodiments. Here, the privacy service 140 maintains and provides both IMEI values and IMSI values to mobile devices.

Similar to the steps 410, 412, and 414 described above with respect to FIGS. 4A-4C, the mobile device 120 first establishes communication with the first wireless entity 114A via its original IMEI and IMSI values (represented by arrow 510). The mobile device 120 then authenticates itself using its original IMEI and/or IMSI values via the authentication service 130 (represented by arrow 512). The authentication service 130 may be associated with the privacy service 140. Once the mobile device 120 is authenticated, it is able to establish communication with the privacy service 140.

The privacy service 140 maintains both a pool of managed IMEI values and a pool of managed IMSI values. The privacy service 140 selects a managed IMEI value and a managed IMSI value from the pools (represented by arrow 516), and sends the managed IMEI value and IMSI value to the mobile device 120 (represented by arrow 518). Notably, a managed IMSI value may be associated with a same or a different wireless entity compared to the wireless entity associated with the original IMSI value. Here, the managed IMSI value is associated with a second wireless entity 114B. Responsive to receiving the managed IMEI value and IMSI value, the mobile device 120 establishes communication with the second wireless entity 114B via the managed IMEI and IMSI values (represented by arrow 522).

In some embodiments, the user can manually select the managed IMEI/IMSI value or the original IMEI/IMSI value for communication. For example, the user may select to use the original IMEI/IMSI value (represented by arrow 524), and the mobile device 120 is caused to switch back to its original IMEI/IMSI value, and use its original IMEI value to communicate with the first wireless entity 114A (represented by arrow 526). In some embodiments, the user can set one or more conditions, when at least one of these conditions are satisfied, the mobile device 120 automatically switches the IMEI/IMSI values between the original IMEI/IMSI values. and the managed IMEI/IMSI values. The conditions may include (but are not limited to) when the mobile device 120 enters a particular geofence, and/or when the mobile device 120 requests for a particular service (e.g., authentication service 130). For example, when a user requests to authenticate via the authentication service 130 again, the mobile device 120 automatically switches itself back to its original IMEI/IMSI values, such that the authentication is performed using the original IMEI/IMSI (represented by arrow 530).

In some embodiments, the user can set up different personas in the carrier application 122, such as work persona, hotel persona, and transit persona. Each persona corresponds to a set of conditions and a set of identifiers (e.g., IMEI/IMSI values). For example, a work persona may correspond to a geofence around a work location, a hotel persona may correspond to a geofence around a hotel, and a transit persona may correspond to a transit location.

FIGS. 6A-6I illustrate examples of graphical user interfaces (GUI) 600A-6001 of the carrier application 122 that allows users to configure and review their privacy settings and identifiers being used. FIG. 6A illustrates a GUI 600A that allows a user to set up a persona and associate a geofence with the persona. At the top, there is a map that shows the current location of the mobile device 120. Below the map, there is a geofence section with fields and controls related to setting up a geofence. The fields include a name field where the user can assign a name to the geofence, a radius where the user can input a radius of the geofence, and a toggle switch where the user can enable or disable the geofence. Below the geofence setting, there is a persona section for managing a persona associated with the geofence. A “switch to persona” field allows the user to select different personas to review or edit the selected persona. At the bottom, there is a delete button for deleting the current persona setting.

FIG. 6B is a GUI 600B that includes a map having three geofences 610, 620, and 630 previously set by the user. The first geofence 610 corresponds to a hotel location, the second geofence 620 corresponds to a transit location, and the third geofence 630 corresponds to a work location. Each of the geofences 610, 620, 630 corresponds to a persona, namely, a hotel persona, a transit persona, and a work persona. Further, in some embodiments, the remaining area 640 that is not within any one of the geofences 610, 620, 630 may also correspond to a persona. Each of the different personas is associated with a separate set of identifiers.

FIG. 6C is a GUI 600C that lists information associated with each persona in text format. As illustrated, the hotel persona is associated with the hotel geofence 610, an IMEI value corresponding to a Samsung A34 phone, and an IMSI value that operates on a mobile carrier based in Singapore known as Starhub. The transit persona is associated with the transit geofence 620A, an IMEI value corresponding to a Huawei P670 Pro phone, and an IMSI value that operates on a mobile carrier based in Hong Kong known as CSL. The work persona is associated with the work geofence 630A, an IMEI value corresponding to Google Pixel 7 phone, and an IMSI value that operates on a mobile carrier based in Poland known as Plus.

The hotel persona is currently active, consistent with the location of the user shown in FIG. 6A. Referring back to FIG. 6B, a location marker 650 indicates that the mobile device 120 is currently in the hotel geofence 610. When the user moves out of the geofence 610 and moves into another geofence 620-640, the different identifiers corresponding to different personas will be activated. The operation of switching the identifiers is also referred to as “flux”.

In FIG. 6C, for each of the inactive personas, e.g., transit persona and work persona, there is a “flux” button available. When the user presses this button, the mobile device 120 is caused to manually perform a flux operation, switching its identifiers to those associated with the pressed flux button.

FIGS. 6D-6F illustrate an example process of automatic flux operation performed based on moving from the hotel geofence to the transit geofence, in accordance with one or more embodiments. In FIG. 6D, the location marker 650 indicates that the user is still in the hotel geofence 610. In FIG. 6E, the location marker 650 is moved from the hotel geofence 610 into the transit geofence 620. In FIG. 6F, a flux operation is performed in response to the location change, and the persona is automatically switched from the hotel persona to the transit persona, and their corresponding identifiers are also switched.

FIGS. 6G-51 illustrate another example of automatic flux operation based on moving from the transit geofence to the work geofence, in accordance with one or more embodiments. In FIG. 6G, the location marker 650 indicates that the user is still in the transit geofence 620. In FIG. 6H, the location marker 650 is moved from the transit geofence 620 into the work geofence 630. In FIG. 6I, a flux operation is performed again in response to the location change, and the persona is automatically switched from the transit persona to the work persona, and their corresponding identifiers are also switched.

Notably, the switching of IMEI here also causes the mobile network to be switched. However, the switching is swift enough such that it is often unnoticeable even if the user is over a streaming service, such as a VoIP call, or an audio or video streaming service. In FIGS. 6E and 6H, there is a cooling down timer at the top, which is triggered by the flux operation. This timer is set as a few seconds (e.g., 15 seconds) by the carrier application 122 when a flux operation is performed. In some embodiments, when the timer is running, new communication requests from some applications are suspended to ensure smooth flux operation.

### Example Methods for Enabling IMEI Value Swapping

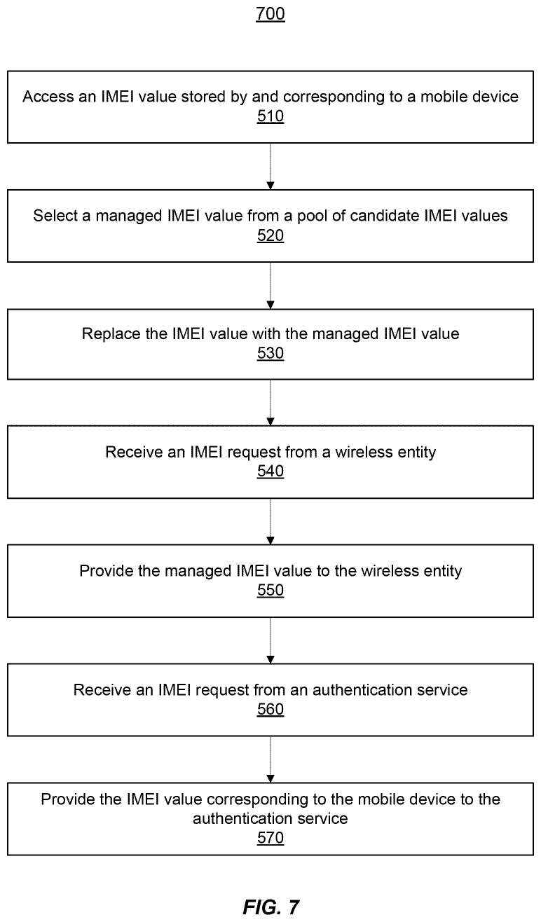

FIG. 7 is a flowchart of an example method 700 for protecting user privacy by enabling swapping of IMEI values in a mobile device in accordance with one or more embodiments. The method 700 may be performed by a mobile device (e.g., mobile device 120), or a combination of the mobile device and an IMEI server (e.g., privacy service 140). Method 700 may include more or fewer steps than those described herein. The steps in method 700 can be performed in any order unless it is explicitly stated that one step must precede another.

The mobile device 120 accesses 710 an IMEI value corresponding to the mobile device 120. The IMEI value may be stored and managed with a modem or a baseband processor and used as an identifier of the mobile device 120's hardware. The mobile device 120 selects 520 a managed IMEI value from a pool of candidate IMEI values and replaces 530 the IMEI value corresponding to the mobile device 120 with the managed IMEI value.

In some embodiments, selecting the managed IMEI value from the pool of candidate IMEI values includes querying an IMEI server configured to check out the managed IMEI value from the pool of candidate IMEI values such that the managed IMEI value cannot be used by another mobile device until the managed IMEI value is checked in by the mobile device 120 via the IMEI server.

In some embodiments, the IMEI server is configured to check out a set of IMEI values from the pool of candidate IMEI values and provide the set of IMEI values to the mobile device such that none of the set of IMIE values is provided to any other mobile device until checked in by the mobile device. The managed IMEI value is selected by the mobile device from the set of IMEI values.

In some embodiments, the managed IMEI value is selected randomly from the pool of the candidate IMEI values. The managed IMEI value, once selected, is not used by any other mobile device. In some embodiments, the managed IMEI value is selected based on a geographic location of the mobile device. In some embodiments, each of one or more geographic boundaries is associated with a candidate IMEI value from the pool of candidate IMEI values. The managed IMEI value includes the candidate IMEI value associated with the geographic boundary in which the mobile device is located. In some embodiments, one or more geographic boundaries are defined by a user of the mobile device, and the managed IMEI value changes as the mobile device moves from a first geographic boundary to a second geographic boundary.

The mobile device 120 may receive IMEI requests from a wireless entity or an authentication service. In response to receiving the IMEI request from the wireless entity, the mobile device 120 provides 550 the managed IMEI value to the wireless entity. In response to receiving an IMEI request from the authentication service, the mobile device 120 provides 570 the IMEI value corresponding to the mobile device to the authentication service. As a result, the wireless entity does not gain access to the IMEI value of the mobile device, and only specific authentication services may be able to obtain it. This prevents the wireless entity from tracking the IMEI value, thereby effectively safeguarding the user's privacy.

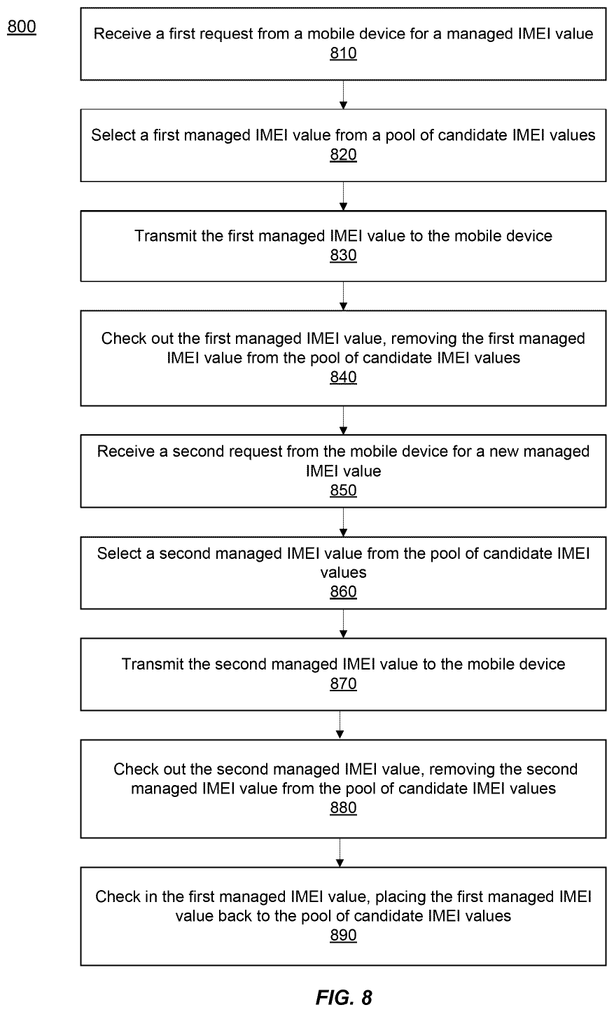

FIG. 8 is a flowchart of an example method 800 for protecting user privacy by facilitating swapping of IMEI values of mobile devices in accordance with one or more embodiments. The method 800 may be performed by an IMEI server (e.g., privacy service 140), or a combination of a mobile device (e.g., mobile device 120) and the IMEI server. Method 800 may include more or fewer steps than those described herein. The steps in method 800 can be performed in any order unless it is explicitly stated that one step must precede another.

The IMEI server maintains the pool of candidate IMEI values. When the IMEI server receives 810 a first request from a mobile device for a managed IMEI value, it selects 820 a first managed IMEI value from the pool of candidate IMEI values, and transmits 830 the first managed IMEI value to the mobile device. Because this first managed IMEI value is now to be used by the mobile device, the IMEI server checks out 840 the first managed IMEI value, removing the first managed IMEI value from the pool of candidate IMEI values.

The mobile device 120 may later request for a new managed IMEI value. When the IMEI server receives 850 a second request from the mobile device for a new managed IMEI value, it selects 860 a second managed IMEI value from the pool of candidate IMEI values, and transmits 870 the second managed IMEI value to the mobile device. Since the mobile device 120 is to be associated with the second managed IMEI value, the IMEI server checks out 880 the second managed IMEI value, removing the second managed IMEI value from the pool of candidate IMEI values. Since the mobile device 120 is no longer associated with the first managed IMEI value, the IMEI server checks in the first managed IMEI value, placing the first managed IMEI value back to the pool of candidate IMEI values.

In some embodiments, when the mobile device checks out a managed IMEI value, the IMEI server retrieves the mobile device's original IMEI value and checks it in, thereby making it available for use by other mobile devices. As such, the IMEI values from many mobile devices are pooled together, and their usage is scrambled. This process makes the usage patterns of any given IMEI value undetectable.

The methods 700 and 800 described herein are directed to managing and enabling the swapping of IMEI values for mobile devices. An ordinary person in the art would understand that similar processes may be implemented to manage and enable swapping of other hardware and/or software identifiers, such as (but not limited to) IMSI values, MAC addresses, Ad IDs, and/or a combination thereof.

### Example Computer

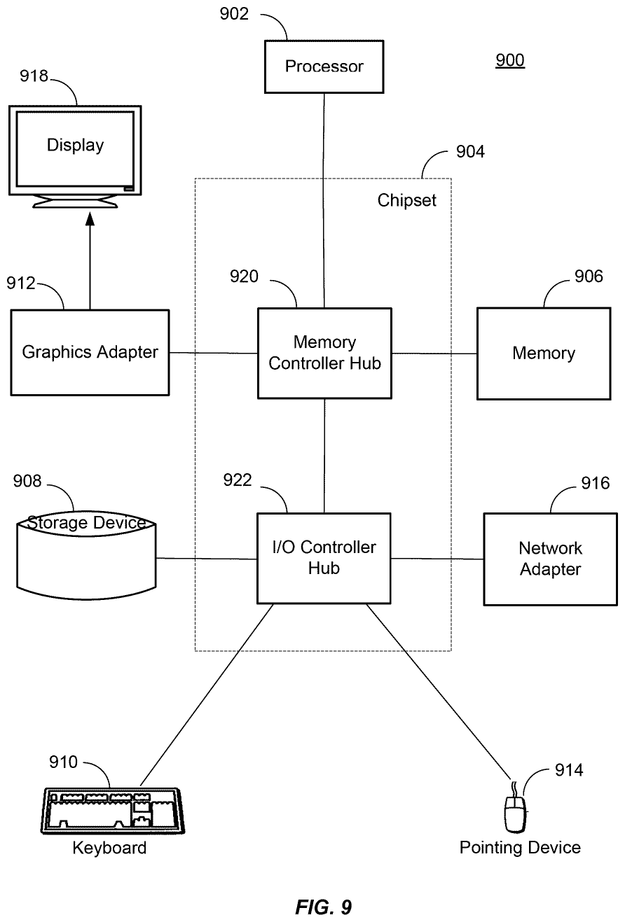

FIG. 9 is a block diagram of an example computer 900 suitable for use in the networked computing environment 100 of FIG. 1. The computer 900 is a computer system and is configured to perform specific functions as described herein. For example, mobile device 120, authentication service 130, and/or privacy service 140 may correspond to the computer 900.

The example computer 900 includes a processor system having one or more processors 902 coupled to a chipset 904. The chipset 904 includes a memory controller hub 920 and an input/output (I/O) controller hub 922. A memory system having one or more memories 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other types of a pointing device and may be used in combination with the keyboard 910 (which may be an on-screen keyboard) to input data into the computer 900. The graphics adapter 912 displays images and other information on the display 918. The network adapter 916 couples the computer 900 to one or more computer networks, such as network 150.

The types of computers used by the mobile device 120 and the privacy service 140 of FIGS. 1 through 3 can vary depending upon the embodiment and the processing power required by the user or the privacy service provider. For example, the privacy service 140 might include multiple blade servers working together to provide the functionality described. Furthermore, the computers can lack some of the components described above, such as keyboards 910, graphics adapters 912, and displays 918.

### Additional Configuration Considerations

Throughout this specification, many instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for mobile device authentication with blinded tokens and swapping the IMSI value of a mobile device through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
accessing an international mobile equipment identity (IMEI) value corresponding to a mobile device and stored in hardware of the mobile device;
selecting a managed IMEI value from a pool of candidate IMEI values;
replacing the IMEI value stored by the mobile device with the managed IMEI value;
in response to receiving an IMEI request from a wireless entity, providing the managed IMEI value to the wireless entity; and
in response to receiving an IMEI request from an authentication service, providing the IMEI value corresponding to the mobile device to the authentication service.

2. The method of claim 1, wherein selecting the managed IMEI value from the pool of candidate IMEI values comprises querying an IMEI server configured to check out the managed IMEI value from the pool of candidate IMEI values such that the managed IMEI value cannot be used by another mobile device until the managed IMEI value is checked in by the mobile device via the IMEI server.

3. The method of claim 2, wherein the IMEI server is configured to:
check out a set of IMEI values from the pool of candidate IMEI values; and
provide the set of IMEI values to the mobile device such that none of the set of IMEI values is provided to any other mobile device until checked in by the mobile device, wherein the managed IMEI value is selected by the mobile device from the set of IMEI values.

4. The method of claim 1, wherein the managed IMEI value is selected randomly from the pool of candidate IMEI values, and wherein the managed IMEI value, once selected, is not used by any other mobile device.

5. The method of claim 1, wherein the managed IMEI value is selected based on a geographic location of the mobile device.

6. The method of claim 1, wherein each of one or more geographic boundaries is associated with a candidate IMEI value from the pool of candidate IMEI values, and wherein the managed IMEI value comprises the candidate IMEI value associated with the geographic boundary in which the mobile device is located.

7. The method of claim 6, wherein one or more geographic boundaries are defined by a user of the mobile device, and wherein the managed IMEI value changes as the mobile device moves from a first geographic boundary to a second geographic boundary.

8. A non-transitory computer-readable medium comprising memory with instructions encoded thereon, the instructions, when executed by one or more processors, causing the one or more processors to perform operations, the instructions comprising instructions to:
access an international mobile equipment identity (IMEI) value corresponding to a mobile device and stored in hardware of the mobile device;
select a managed IMEI value from a pool of candidate IMEI values;
replace the IMEI value stored by the mobile device with the managed IMEI value;
in response to receiving an IMEI request from a wireless entity, provide the managed IMEI value to the wireless entity; and
in response to receiving an IMEI request from an authentication service, provide the IMEI value corresponding to the mobile device to the authentication service.

9. The non-transitory computer-readable medium of claim 8, selecting the managed IMEI value from the pool of candidate IMEI values comprises querying an IMEI server configured to check out the managed IMEI value from the pool of candidate IMEI values such that the managed IMEI value cannot be used by another mobile device until the managed IMEI value is checked in by the mobile device via the IMEI server.

10. The non-transitory computer-readable medium of claim 9, wherein the IMEI server is configured to check out a set of IMEI values from the pool of candidate IMEI values and to provide the set of IMEI values to the mobile device such that none of the set of IMEI values is provided to any other mobile device until checked in by the mobile device, wherein the managed IMEI value is selected by the mobile device from the set of IMEI values.

11. The non-transitory computer-readable medium of claim 8, wherein the managed IMEI value is selected randomly from the pool of candidate IMEI values, and wherein the managed IMEI value, once selected, is not used by any other mobile device.

12. The non-transitory computer-readable medium of claim 8, wherein the managed IMEI value is selected based on a geographic location of the mobile device.

13. The non-transitory computer-readable medium of claim 12, wherein each of one or more geographic boundaries is associated with an candidate IMEI value from the pool of candidate IMEI values, and wherein the managed IMEI value comprises the candidate IMEI value associated with the geographic boundary in which the mobile device is located.

14. The non-transitory computer-readable medium of claim 13, wherein one or more geographic boundaries are defined by a user of the mobile device, and wherein the managed IMEI value changes as the mobile device moves from a first geographic boundary to a second geographic boundary.

15. A system comprising:
a processor; and
a non-transitory computer-readable medium storing instructions that, when executed by the processor, cause the processor to:
access an international mobile equipment identity (IMEI) value corresponding to a mobile device and stored in hardware of the mobile device;
select a managed IMEI value from a pool of candidate IMEI values;
replace the IMEI value stored by the mobile device with the managed IMEI value;
in response to receiving an IMEI request from a wireless entity, provide the managed IMEI value to the wireless entity; and
in response to receiving an IMEI request from an authentication service, provide the IMEI value corresponding to the mobile device to the authentication service.

16. The system of claim 15, wherein selecting the managed IMEI value from the pool of candidate IMEI values comprises querying an IMEI server configured to check out the managed IMEI value from the pool of candidate IMEI values such that the managed IMEI value cannot be used by another mobile device until the managed IMEI value is checked in by the mobile device via the IMEI server.

17. The system of claim 16, wherein the IMEI server is configured to check out a set of IMEI values from the pool of candidate IMEI values and to provide the set of IMEI values to the mobile device such that none of the set of IMEI values is provided to any other mobile device until checked in by the mobile device, wherein the managed IMEI value is selected by the mobile device from the set of IMEI values.

18. The system of claim 15, wherein the managed IMEI value is selected randomly from the pool of candidate IMEI values, and wherein the managed IMEI value, once selected, is not used by any other mobile device.

19. The system of claim 15, wherein the managed IMEI value is selected randomly from the pool of candidate IMEI values, and wherein the managed IMEI value, once selected, is not used by any other mobile device.

20. The system of claim 15, wherein the managed IMEI value is selected based on a geographic location of the mobile device.
